(19) United States
(12) Patent Application Publication
(10) Pub. No.: US 2007/0049203 A1
(43) Pub. Date: Mar. 1, 2007

(54) System and method for adjusting the coverage footprint of an antenna

(76) Inventors: Matt J. Dillon, Hawthorn Woods, IL (US); John M. Harris, Chicago, IL (US)

Correspondence Address: MOTOROLA, INC., 1303 EAST ALGONQUIN ROAD, IL01/3RD, SCHAUMBURG, IL, 60196, US

(21) Appl. No.: 11/214,091

(22) Filed: Aug. 29, 2005

(51) Int. Cl. H04B 1/00; H04B 1/02; H04B 15/00

(52) U.S. Cl. 455/63.4; 455/101

(57) ABSTRACT

At least one weighting factor associated with at least one user operating in a wireless network is obtained. A common channel coverage footprint (104) of a smart antenna (103) is adjusted based upon the at least one weighting factor.

### FIELD OF THE INVENTION

The field of the invention relates to antennas and, more specifically, to adjusting the transmission characteristics of antennas.

### BACKGROUND OF THE INVENTION

Smart antenna technologies that allow the characteristics of an antenna to be changed are often used to enhance the effectiveness and quality of transmissions from base stations to mobile stations. Typically, smart antennas transmit signals over both traffic and common communication channels. The traffic channels usually carry voice data (or other types of data) while the common communication channels are typically used to carry paging and control messages to the mobile stations.

Communication networks are often divided into cells and mobile stations move across and within cells. The antennas transmit over a coverage footprint to the mobile stations with some areas of the footprint having a better reception quality than other areas. In addition, areas or seams of the footprint sometimes may overlap with other footprints or seams from other base stations, especially around the edges.

Because reception quality was not always uniform across a footprint, previous systems often suffered from reduced overall performance with respect to the common channel transmissions. For instance, excessive interference often developed for mobile stations that were located at the edge of the footprint and/or in multiple seams. High path-loss of information was also frequently a problem in these situations. In addition, mobile stations sometimes became “stranded” at a location where the access or control channels were unable to reach the mobile station.

Unfortunately, previous systems did not address these problems. Mobile stations that suffered from poor-quality transmissions often had to move to a better location in order for the quality of the transmission to be improved. Consequently, situations often developed where users became unreachable and/or the quality of service became so degraded that calls were unable to be completed.

### BRIEF DESCRIPTION OF THE DRAWINGS

FIG. 1 is a block diagram of a system for adjusting the coverage footprint of a smart antenna according to the present invention;

FIG. 2 is a block diagram of a device for adjusting the coverage footprint of a smart antenna according to the present invention;

FIG. 3 is a flowchart of an approach for operating a smart antenna according to the present invention;

FIG. 4 is a flowchart of an approach for operating a smart antenna according to the present invention; and

FIG. 5 is a diagram of a table that stores information used to adjust the coverage footprint of a smart antenna according to the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method is described wherein the common channel footprint of a smart antenna is adjusted based upon a variety of weighting factors. For instance, overlapping coverage seams can be substantially eliminated to reduce interference encountered by mobile stations. In another example, all mobile stations can be reached by a control channel, thereby eliminating the problem of stranded mobile stations.

In many of these embodiments, at least one weighting factor associated with a user operating in a wireless network is obtained. A smart antenna is used to transmit common channel communications to a mobile station over a control channel having a common channel coverage footprint. The footprint is adjusted based upon the weighting factor.

The weighting factor(s) may be associated with a variety of different characteristics associated with users and/or user devices. For instance, the weighting factor(s) may indicate the likelihood that the user will receive a call, the likelihood that the user will place a call, the likelihood that the user will send packets, the likelihood that the user will receive packets, whether the user is a premium user, the battery life of a mobile station associated with the user, a wireless traffic pattern, the likelihood that the user will participate in a group call with another user, or the likelihood that the user will receive the same page as another user. In other examples, the amount of edge sharing may be used as a weighting factor. Other examples of weighting factors are possible.

Various types of adjustments may be made to the smart antenna and these may alter different aspects of the common channel coverage footprint. In one example, the physical coverage area of the smart antenna may be adjusted (i.e., increased or decreased) so as to minimize the number of users which are operating in a seam associated with the common channel coverage footprint. In another example, the gain of common channel transmissions made by the smart antenna can be altered.

In some of these embodiments, the pilot signal strength reports of mobile stations operating within a coverage area of the smart antenna are received. The reports are correlated and the signal strengths converted into angle and distance pairs, with each pair representing a coverage area. In addition, weighting factors (such as the amount of edge-sharing) may be determined or obtained for each of the angle/distance pairs. Adjustments to the common channel coverage footprints can then be made based upon the weighting factors.

Thus, approaches are described that enhance the performance of mobile stations by optimizing the characteristics of common channel footprints for common channel transmissions. Since the coverage footprint is optimized, interference and other problems encountered by mobile stations can likely be substantially reduced or eliminated.

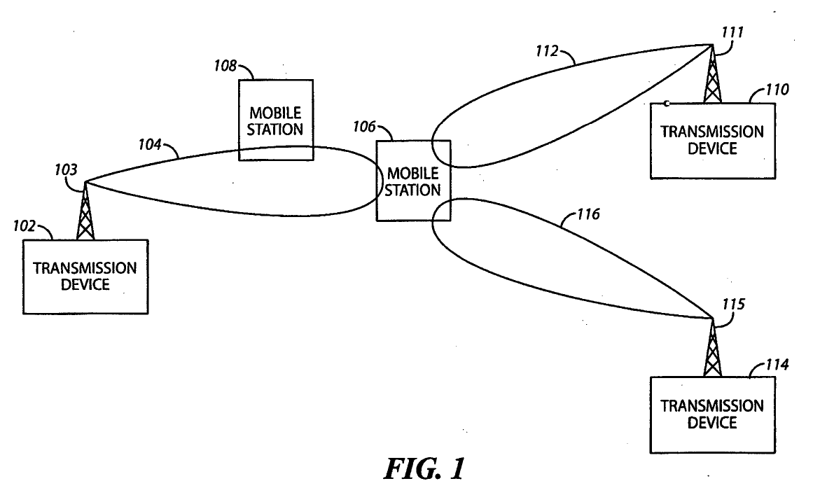

Referring now to FIG. 1, a system for adjusting the coverage footprint of a smart antenna is now described. A first transmission device 102 (including a first smart antenna 103) transmits control signals over a control channel. The first smart antenna 103 has a first coverage footprint 104. A second transmission device 110 (including a second smart antenna 111) transmits control signals over the same or a different control channel. The second smart antenna 111 has an associated coverage second foot print 112. A third transmission device 114 (including a third smart antenna 115) transmits control signals over a control channel that may be the same or different from the control channels mentioned above. The third smart antenna 115 has an associated third coverage footprint 116.

The smart antennas 103, 111, and 115 may be any antenna system or combination of systems that are capable of focusing their transmitted signals on an intended target and/or having their other operating characteristics adjusted. As described elsewhere in this specification, the coverage footprints associated with the smart antennas 103, 111, and 115 are adjusted according to weighting factors, thereby enhancing the quality of the signals received by mobile stations.

As shown in FIG. 1, a first mobile station 106 operates at the edge of the first coverage footprint 104. The first mobile station 106 also operates at the edge of the second coverage footprint 112 and third coverage footprint 116. A second mobile station 108 operates at the edge of the first coverage footprint 104. However, the second mobile station 108 does not operate in any of the other coverage footprints.

These mobile stations 106 and 108 may be any type of wireless mobile device. For example, these mobile stations 106 and 108 may be cellular telephones, pagers, personal digital assistants, or personal computers. Other types of mobile stations are possible.

The transmission devices 102, 110, and 114 include functionality that controls the operation of the smart antennas. In this regard, the transmission devices receive weighting factors that, as described in detail elsewhere in this specification, are used to adjust the coverage footprints 104, 112, and 116.

In one example of the operation of the system of FIG. 1, at least one weighting factor associated with a user operating the first mobile station 106 is obtained. The first common channel coverage footprint 104 of the smart antenna 103 is adjusted based upon the at least one weighting factor.

In one example, the smart antenna 103 may be adjusted so as to minimize the number of users which are operating in a seam associated with the common channel coverage footprint 104. In another example, the gain of common channel transmissions made from the smart antenna 103 may be adjusted.

The weighting factors may relate to a number of different characteristics of users and/or devices operating in the network. For instance, the weighting factors may indicate the likelihood that the user will receive a call, the likelihood that the user will place a call, the likelihood that the user will send packets, the likelihood that the user will receive packets, whether the user is a premium user, the battery life of a mobile station associated with the user; a wireless traffic pattern, the likelihood that the user will participate in a group call with another user, and the likelihood that the user will receive the same page as another user. In another example, the amount of edge sharing can be used as a weighting factor. Other examples of weighting factors are possible.

In another example of the operation of the system of FIG. 1, the pilot signal strength of the first mobile station 106 operating within a coverage area of the smart antenna is obtained from another mobile station (e.g., mobile station 108) that is now dormant. The pilot signal strength may be converted, for example, into an angle and a distance, and weighting factors (e.g., such as an amount of edge-sharing or whether a user is a premium user) may be obtained or determined. Adjustments to the transmission coverage footprint can be determined based upon these weighting factors.

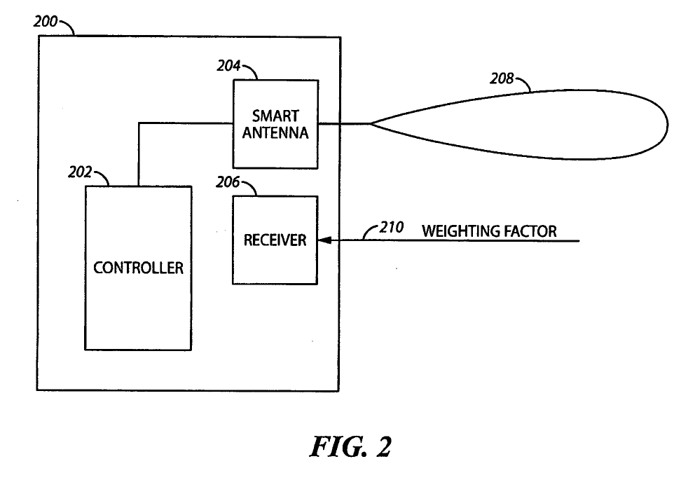

Referring now to FIG. 2, one example of a transmission device 200 that adjusts a coverage footprint of a smart antenna is described. The device 200 includes a controller 202, smart antenna 204, and receiver 206.

The controller 202 is programmed to obtain at least one weighting factor 210 related to a user characteristic at the input of the receiver 206 and is further programmed to adjust a transmission coverage footprint 208 of the smart antenna 204 based upon the weighting factor 210.

The coverage footprint 208 may be adjusted by using several different techniques. For instance, the controller 202 may be programmed to adjust operation of the smart antenna 204 so as to minimize a number of users in overlapping seams associated with the transmission coverage footprint 208. In another example, the controller 202 may be programmed to adjust a gain of common channel transmissions made from the smart antenna 204 according to the weighting factor.

The weighting factor 208 may potentially include any type of information related to users as may be pertinent in a given application setting. For example, the weighting factor may be related to the likelihood that a wireless user will receive a call, whether a wireless user is a premium user, the battery life of a mobile station associated with a user, a wireless traffic pattern, or the likelihood that a user will receive a same page as another user. Other examples of weighting factors are possible and may be used.

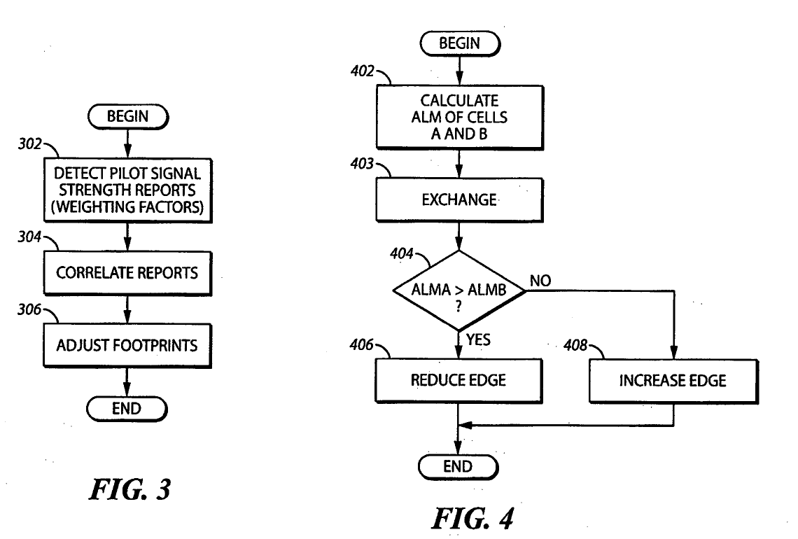

Referring now to FIG. 3, one example of an approach for adjusting the common channel coverage footprint of a smart antenna is described. At step 302, the pilot signal strength reports are detected for mobile stations operating within the coverage area of the smart antenna.

At step 304, the pilot signal reports are correlated according to weighting factors. In one example, a table is formed wherein the signal strength measurements are converted into coverage area parameters (e.g., an angle and edge distance pair). For each angle and distance pair, associated weighting factors, for instance, a traffic weight and an edge-sharing value, may be calculated. Users can also be prioritized according to other weighing factors. For instance, users having made more recent reports, premium users, low battery life users, and users that are likely to receive a talk burst may be identified as deserving special or premium treatment from the smart antenna.

At step 306, the coverage footprint is adjusted based upon the weighting factors. For example, the amount of edge coverage area can be expanded or contracted based upon the amount of overlap with other cells and traffic weighting. In another example, the transmission pattern of the antenna can be adjusted so as to transmit signals directly to premium users. In another approach, the coverage area can be expanded to include a mobile station when the mobile station moves out of the coverage area and no other cell serves the mobile station. In still another example, the coverage area can be moved away from higher densities of likely receivers. In another approach, if the gain is limited or the coverage area is loaded, the edge of the coverage area can be contracted.

Referring now to FIG. 4, another example of an approach for adjusting the coverage footprint of a smart antenna is described. At step 402, the Average Loading Metric (ALM) of two nearby cells A and B is determined. The ALM loading metric may be a combination of the quality-of-service penalties and weights. In one example, ALM is defined as:
ALM=A*(weighting factor)+B*(Request denied backhaul)+C*(call requests)

A and B may be weighted values. “Request denied backhaul” indicates the number of backhaul requests that have been denied and “call requests” indicates the number of requests for a call. And, “weighting factor” may have a value that is given by the equation:
Weighting factor=x*traffic usage+y*(HHO+O/T)

In this equation, the traffic usage is the throughput/voice user throughput; O/T is the number of originations and terminations; HHO is the number of hard handoffs; and, x and y are adjustable values that are used to take into account traffic loading conditions (i.e., heavy and light users) and overhead channel loading (real time usage).

At step 403, the ALM is exchanged between neighboring cells after a predetermined number of seconds expires. At step 404, it is determined whether the ALM of cell A is greater than the ALM of cell B. If the answer is affirmative, at step 406, the edge of the coverage area is reduced. If the answer is negative, at step 408 the edge of the coverage area is increased. In this example, the reduction or increase in the coverage area is proportional to the number of users in the seam or coverage area. For example, the more users within a coverage area, the larger the amount of allowed movement.

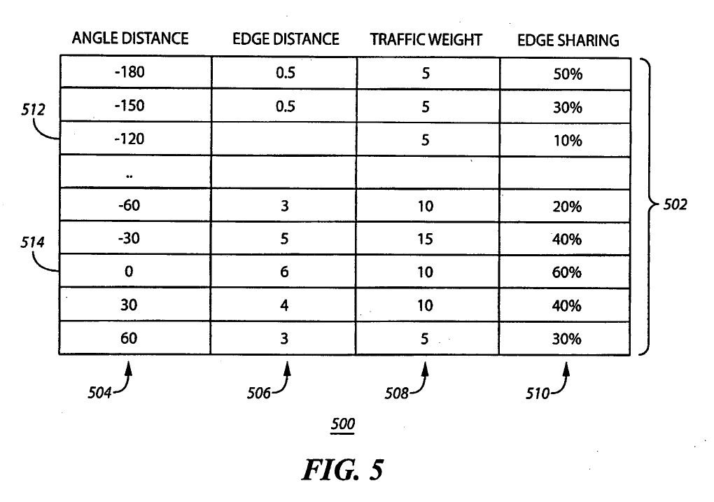

Referring now to FIG. 5, an example of a table 500 that may be preferably used to adjust the coverage footprint of a smart antenna is described. This table includes a plurality of rows 502 with each row defining a coverage pattern and weighting factors associated with the coverage pattern. The characteristics of a coverage pattern are defined by the columns in the table 500. Specifically, an angle distance column 504 defines a horizontal angle relative to the smart antenna. An edge distance column 506 defines the distance to the edge of the coverage area. A traffic weight column 508 defines a traffic weight for the coverage area. Finally, an edge sharing column 510 defines a value indicting the percentage of mobiles sharing another coverage area.

The values for the angle distance column 504 and the edge distance column 506 may be converted directly from pilot signal reports received from mobile stations using techniques that are known in the art. In addition, the values for the traffic weight column 508 and the edge sharing column 510 may be calculated by the approaches described below.

For instance, the value to be placed in traffic weight column 508 can be determined by:
Traffic Weight=x*traffic usage+y*(HHO+O/T)

In this equation, the traffic usage is the throughput/voice user throughput; O/T is the number of originations and terminations; HHO is the number of hard handoffs; and, x and y are adjustable values that are used to take into account traffic loading conditions (i.e., heavy and light users) and overhead channel loading (real time usage).

In another example, the value to be stored in the edge sharing column 510 value can calculated as:
Edge Sharing=Σ(if(Serv_{—}RSSI−Neigh_{—}RSSI)<Z); i++/ΣServRSSI_reports

In this equation, Serv_RSSI is the serving or best received signal strength indication, Neigh_RSSI is the best received signal strength indication for neighboring cells, and Z is a hysterisis margin.

After the values for the columns 508 and 510 have been determined, the system may periodically examine the table 500 in order to determine appropriate adjustments that should be made to the coverage area. For instance, the system may examine the row 512 and determine that since there is little edge sharing, the size of the coverage area should not be reduced. On the other hand, the system may examine the row 514 and determine that since a large amount (i.e., 60 percent) of edge sharing is occurring, the size of the coverage area can be reduced.

Thus, approaches are described that enhance the performance of mobile stations within networks by optimizing the size of coverage areas for common channel transmissions. Since the coverage footprint is optimized, interference and other problems encountered by mobile stations can likely be substantially reduced or eliminated.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of transmitting information using a smart antenna comprising:
obtaining at least one weighting factor associated with at least one user operating in a wireless network; and
adjusting a common channel coverage footprint of a smart antenna based upon the at least one weighting factor.

2. The method of claim 1 wherein adjusting the common channel coverage footprint comprises adjusting the smart antenna so as to minimize a number of users which are operating in at least one seam associated with the common channel coverage footprint.

3. The method of claim 1 wherein adjusting the transmission coverage footprint comprises adjusting a gain of common channel transmissions made from the smart antenna.

4. The method of claim 1 wherein obtaining at least one weighting factor comprises obtaining at least one weighting factor selected from a group comprising: a likelihood that the at least one user will receive a call; a likelihood that the at least one user will place a call; a likelihood that at least one user will send packets; a likelihood that at least one user will receive packets; whether the at least one user is a premium user; a battery life of a mobile station associated with the at least one user; a wireless traffic pattern; a likelihood that the at least one user will participate in a group call with another user; and a likelihood that the at least one user will receive a same page as another user.

5. The method of claim 1 wherein obtaining at least one weighting factor comprises capturing a pilot signal strength of at least one mobile station operating within a coverage area of the smart antenna from another mobile station that is dormant.

6. The method of claim 5 wherein adjusting the transmission coverage footprint comprises converting the pilot signal strength into an angle and a distance, and determining adjustments to the transmission coverage footprint based upon the angle and the distance.

7. A method of transmitting information from a smart antenna comprising:
collecting historical data associated with calls made to at least one mobile station while the mobile station was in a coverage area of a smart antenna;
determining at least one weighting factor from the historical data; and
adjusting a transmission coverage footprint of transmissions made over a common channel of the smart antenna to the at least one mobile station based upon the at least one weighting factor.

8. The method of claim 7 wherein determining at least one weighting factor comprises correlating reports associated with the historical data.

9. The method of claim 7 wherein obtaining historical data comprises obtaining a pilot signal strength report of the at least one mobile station.

10. The method of claim 9 wherein adjusting the transmission coverage footprint comprises converting the pilot signal strength into an angle and a distance, and determining adjustments to the transmission coverage footprint based upon the angle and the distance.

11. The method of claim 7 wherein determining at least one weighting factor comprises obtaining at least one weighting factor selected from a group comprising: a likelihood that the at least one mobile station will receive a call; whether the at least one mobile station is associated with a premium user; a battery life of the at least one mobile station; a wireless traffic pattern; and a likelihood that the at least one mobile station will receive a same page as another mobile station.

12. A transmission device comprising:
a smart antenna;
a receiver having an input; and
a controller coupled to the smart antenna and the receiver, the controller being programmed to obtain at least one weighting factor related to a user characteristic at the input of the receiver, the controller being further programmed to adjust a transmission coverage footprint of the smart antenna based upon the at least one weighting factor.

13. The device of claim 12 wherein the controller is further programmed to adjust operation of the smart antenna so as to minimize a number of users in overlapping seams associated with the transmission coverage footprint according to the at least one weighting factor.

14. The device of claim 12 wherein the controller is further programmed to adjust a gain of common channel transmissions made from the smart antenna according to the at least one weighting factor.

15. The device of claim 12 wherein the at least one weighting factor is selected from a group comprising: a likelihood that a wireless user will receive a call; whether a wireless user is a premium user; a battery life of a mobile station associated with a user; a wireless traffic pattern; a likelihood that a user will receive a same page as another user.

16. The device of claim 12 wherein the receiver obtains a pilot signal strength at the input for all mobile stations within a coverage area of the smart antenna.

17. The device of claim 16 wherein the controller is further programmed to convert the pilot signal strength into an angle and a distance and to determine adjustments to the transmission coverage footprint based upon the angle and the distance.

18. The device of claim 16 wherein the controller comprises means for converting the pilot signal strength into an angle and a distance and for determining adjustments to the transmission coverage footprint based upon the angle and the distance.
